(19) United States
(12) Patent Application Publication
(10) Pub. No.: US 2008/0193371 A1
(43) Pub. Date: Aug. 14, 2008

(54) Molecular Sieves Based Nano-Composite Uv-Resistant Material, Preparation Process and Use Thereof

(76) Inventors: Lei Zhang, Shanghai (CN); Shaomin Wei, Shanghai (CN); Limin Wu, Shanghai (CN); Yiguang Guo, Shanghai (CN)

Correspondence Address: BUTZEL LONG;IP DOCKETING DEPT, 350 SOUTH MAIN STREET, SUITE 300, ANN ARBOR, MI, 48104, US

(21) Appl. No.: 10/580,894

(22) PCT Filed: Nov. 19, 2004
(86) PCT No.: PCT/CN2004/001316

§ 371 Date: May 26, 2006

(30) Foreign Application Priority Data
Nov. 28, 2003 (CN) 200310108974.3

(51) Int. Cl. C01B 39/00

(52) U.S. Cl. 423/700

(57) ABSTRACT

The present invention provides a novel UV-resistant material, which is a host-guest nano-composite made with micro- and mesoporous molecular sieves of types X, Y, A, STI, ASM-5, MCM-41 and the series thereof, and SBA and the series thereof being the host and the nano-cluster Ti0₂, ZnO, Ce0₂, and Fe₂0₃ being the guest. The composite represents strong absorption in the UVA-UVB ranges, which can be used as the UV resistant agent in cosmetics, coatings, rubber and plastic industry.

### FIELD OF THE INVENTION

The present invention relates to the preparation of UV-resistant materials. More particularly, the present invention relates to UV-resistant materials which comprise crystalline porous materials such as zeolite molecular sieves and mesoporous molecular sieves that support nano-clusters of Ti0₂, ZnO, Ce0₂, and Fe₂0₃. The present invention further relates to preparation methods and uses of the UV-resistant materials.

### BACKGROUND OF THE INVENTION

As a result of the development of modern industry, atmospheric pollution is getting worse and the damage level of the ozonesphere is seriously increasing in recent years. It is an imminent problem to resist the ultraviolet radiation in quite a number of the fields. The hazard of excess UV is mainly incarnated in the following aspects:

1: The peptide chains of the protein will be damaged when an organism is exposed to uv irradiation, resulting in the production of free radicals. The free radicals will further react with other peptide chains and eventually result in tissue damage and gene mutation. For a human body, it will result in skin burn injury and the production of skin cancer. Using sun-prevent cosmetics is one of the efficient ways to prevent these problems.

2: The ultraviolet light as a high energy wavelength which leads to molecular industrial product aging and shortening the lives of products. Therefore, in general, UV-resistant agents are added to high molecular products.

In some countries, such as the United States, Japan and Europe, the research and the use of sun-prevent cosmetics have reached a high level and sun-preventative cosmetics have become a key focus of the development of cosmetics for skincare. The annual growth rate of sun-preventative cosmetics is 5-10% in Europe. It has been reported that the yield of sun-preventative cosmetics accounted for a half of the inventory of the cosmetics in 1990 in the United States. In China, with the rapid progress of the living standard, and enhancement of people's consciousness of aesthetics and health care, many people are paying more attention to UV protection. The increasing growth rate of the sun-preventative product market in China has remained above 20% from the 1990s. Moreover, UV-resistant agents are also used more and more. In the plastic materials and rubber industries, and especially in the paint industry, highly active and steady UV-resistant agents have always been a key point of research and development.

At present, developed UV-resistant materials include two main classes of chemical and physical, with the use of the former being more popular. Chemical UV-resistant agents in general are organic compounds. Therefore, they have good compatible, but also generally have certain toxicity and irritancy to the skin. They are not compatible with current health concerns of people, because it is easy to cause anaphylaxis when they are used in the products which come in direct contact with the skin. In addition, the organo-UV-resistant agents always have bad photostability and they will decompose or become oxidized when exposed to UV radiation. The development of nanotechnology allows for solutions for resolving the above problems. There are physical UV-resistant agents developed with nanotechnology, e.g., abio-nanometer UV-resistant agents. Abio-nanometer UV-resistant agents have characteristics of stabilization and broad-spectrum resistance which make up for the disadvantages of organo-UV-resistant agents to a certain degree. The shortcomings of abio-Nanometer UV-resistant agents have been increasingly apparent as applications have been developed. The surface activity is the most typical shortcoming. Because of the high surface energy of the abio-Nanometer particles, when they are mixed with an organic phase, coacervation easily occurs and results in the inactivation of the UV-resistant agents. In addition, security is also one of the potential problems encountered in of the application of the nanometer particles.

For instance, nano-ZnO and nano-TiO₂ have photocatalytic reactiveness and will produce free radicals when exposed to daylight, resulting in harm to human DNA. John Kownland et al. of Oxford have researched the negative effects of and ZnO extensively. It is stated that TiO₂ and ZnO produce oxygen and oxyhydrogen free radicals in photoillumination. Contrary to prior belief, it has been proven that it is oxyhydrogen free radicals that harm human DNA, while oxygen radicals do not. Therefore, the method of adding oxygen radical scavenging agents to prevent harm caused by TiO₂ and ZnO is not enough. Nano-cluster assemblies with molecular sieves being the host or supports can resolve the above problem drastically.

A molecular sieve is a kind of crystalline and porous material. Its porous channels have a characteristic of narrow distribution of pore size and high-ordered microstructure. Using the porous channel structure of a molecular sieve as a template and assembling the guest molecules into the porous channels results in a high ordered nano-cluster arrangement. The assembling technique can not only ensure the dispersion of the nano-cluster, but can also enhance the performance of the nano-cluster to a large extent. Many assembling methods have been developed in this field. In researching the assembling methods of semiconductor-guest, coordination compound-guest and some macromolecule organo-guest, a kind of technique known as “ship in bottom” has been developed. In short, this method introduces the guest monomer micromolecules into the porous channels of the molecular sieve, then initiates the condition of synthetic reaction in the porous channels to occur causing a combination reaction. Using an in situ synthetic method sometimes provides a good effect when assembling some nitrogen-containing or nitrogen-based organo-guests. The composite materials obtained by the above methods behave as macro granulometric patterns yet have nano-cluster characteristics. Furthermore, because of the template action of the porous channels of the molecular sieve, the guests behave in an ordered microscopic height. As a result, the material properties can be changed by an order of magnitude.

This type of assembling methods appears particularly suitable in sun-preventative cosmetics, coatings, rubber and plastics industries. Whether using the conventional organo-ultraviolet absorption materials or the new style abio-ultraviolet absorption materials, the technical group of these materials can be placed into the porous channels of the molecular sieve to avoid the coacervation of nanometer particles. This technical solution can also reduce the side-effect of the ultraviolet absorption agent. It is more important that the performance of ultraviolet absorption can be extremely enhanced by reason of the high ordered microscopic state of the ultraviolet absorption agent.

One object of the present invention is to provide UV-resistant materials.

Another object of the present invention is to provide methods for preparing the UV-resistant materials.

Another object of the present invention is to provide uses for the UV-resistant materials.

### THE DESCRIPTION OF THE INVENTION

The present invention provides a UV-resistant materials which use molecular sieve based host-guest nano-composite materials as ultraviolet absorption agents. The host is selected from one or more than one material of micro- and mesoporous molecular sieve-type materials such as X, Y, A, STI, ZSM-5, MCM-41 and the series thereof, and SBA and the series thereof. The guest-cluster is selected from one or more than one material of Ti0₂, ZnO, Ce0₂, and Fe₂0₃. This kind Of UV-resistant material uses the microscopic ordered porous channels of the molecular sieve as a template. The guest-cluster is directional with high-order by the quantum confinement effect. In the nano-cluster it can be ensured that only the interval plane of the nano-clusters exist steadily. In addition, the performance is improved greatly.

The present invention also provides two preparation methods of the UV-resistant materials.

The first preparation method uses any one or more than one material of TiCl₃, Ti(NO₃)₃, ZnCl₂, Zn(NO₃)₂, CeCl, Ce(NO₃)₃, FeCl₃, Fe(NO₃)₃, FeSO₄ as the initiating material to synthesize the host-guest nano-composite materials by means of ion exchange, which are TiO₂, ZnO, CeO₂, Fe₂O₃ metal oxide nano-cluster and the molecular sieve compound. The product is used as the ultraviolet absorption agent to obtain the UV-resistant materials.

This method includes following steps: dissolving the initiating material in the water, adding the molecular sieve, stirring at room temperature for 3-12 hours, filtrating, washing, and torrefying at 400-600° C. for 4-24 hours.

Alternatively, dissolving the initiating material in the water, adding low-silicon molecular sieve, resting for 1 hours, filtrating, washing and drying at 80° C., and torrefying for at 500° C. 12 hours.

The second preparation method uses butyl titanate as the initiating material to synthesize host-guest nano-composite materials of TiO₂ cluster within a molecular sieve compound by means of hydrolytic reaction. The product is used as the ultraviolet absorption agent to obtain UV-resistant materials.

This method include following steps: mixing butyl titanate with high-silicon molecular sieve in non-polar solvent with inert gas shielding, refluxing and agitating at 50-100° C. for 4-48 hours, washing the product with an alcohol type solvent, drying at 60-100° C., and torrefying for 4-24 hours at 400-600° C.

The present invention further provides uses of the UV-resistant materials In cosmetics, coatings, rubber and plastics industries.

### EMBODIMENT

The present invention will be further described with reference to the following non-limiting examples to which the invention is not to be considered limited.

### Example 1

### Assembling of X Zeolite and ZnO

1) 10.00 g of Zn(NO₃)₂ was weighted out and dissolved in 40 ml deionized water;

2) 2.00 g of X zeolite was weighted out and mixed in the above solution, while maintaining the pH at 4˜5;

3) The mixture was electromagnetically stirred for 1 hour at 40˜50° C.;

4) After resting a moment, the supernatant liquor was poured off and discarded after delamination, and 10.00 g of Zn(NO₃)₂ was weighted out and dissolved 40 ml water, followed by electromagnetic stirring for 1 hour;

5) Step 4 was repeated three followed by filtrating the solution in a buchner funnel in the last time, repetitive washing by deionized water was performed to remove impurity ions in the solution and Zn²⁺ out of the framework of the zeolite molecular sieve, then the resulting product was placed it in an oven and dried for about 30 minutes at 60° C.;

6) The obtained product was triturated in an agate mortar for 10˜15 minutes, then placed in a 30 ml firepot, and torrefied for 6 hours in a muffle furnace at 550° C.;

7) The powdered product was taken out the firepot and triturated for 10˜15 minutes by replacing it into the muffle furnace and torrefying for 6 hours under the same condition to obtain the product H—X—ZnO powder form.

### Example 2

### Assembling of Y Zeolite and ZnO

1) 10.00 g of Zn(NO₃)₂ was weighted out and dissolved in 40 ml deionized water;

2) 2.00 g of Y zeolite was weighted out and mixed in the above solution which was maintained at a pH of 4˜5;

3) The solution was subjected to electromagnetic stirring for 1 hour at 40˜50° C.;

4) After resting, the supernatant liquor was discarded after delamination, and 10.00 g of Zn(NO₃)₂ was weighted out and dissolved in 40 ml water and subjected to electromagnetic stirring for 1 hour;

5) Step 4 was repeated three times and then the solution was filtered in a buchner funnel 4 the last time followed by repetitive scrubbing by deionized water to remove impurity ions in the solution and Zn²⁺ out of the framework of the zeolite molecular sieve, the resulting product was placed in an oven and dried for about 30 minutes at 60° C.;

6) The obtained product was triturated in an agate mortar for 10˜15 minutes, then placed in a 30 ml firepot and torrefied for 6 hours in a muffle furnace at 550° C.;

7) The powdered produce was taken out the firepot and triturated for 10˜15 minutes by replacing it into the muffle furnace and torrefying for 6 hours under the same condition to obtain the product H—Y—ZnO powder form.

### Example 3

### Assembling of A Zeolite and ZnO

1) 10.00 g of Zn(NO₃)₂ was weighted out and dissolved in 40 ml deionized water;

2) 2.00 g zeolite was weighted out and mixed with the above solution which was maintained at a pH of 4˜5;

3) The solution was subjected to electromagnetic stirring for 1 hours hour at 40˜50° C.;

4) After resting, the supernatant liquor was discarded after delamination, and 10.00 g of Zn(NO₃)₂ was weighted out and dissolved in 40 ml water and subjected to electromagnetic stirring for 1 hours;

5) Step 4 was repeated for three times and then the solution was filtered in a buchner funnel in the last time followed by repetitive washing by in deionized water to remove impurity ions in the solution and Zn²⁺ out of the framework of the zeolite molecular sieve, the resulting product was placed in an oven and dried for about 30 minutes at 60° C.;

6) The obtained product was triturated in an agate mortar for 10˜15 minutes, then placed in a 30 ml firepot and torrefied for 6 hours in a muffle furnace at 550° C.;

7) The powdered produce was taken out of the and triturated for 10˜15 minutes, then replaced into the muffle furnace and torrefied for 6 hours under the same condition to obtain the product H-A-ZnO powder form.

### Example 4

### Assembling of STI Zeolite and ZnO

1) 10.00 g of Zn(NO₃)₂ was weighted out and dissolved in 40 ml deionized water;

2) 2.00 g of STI zeolite and mixed into the above solution and maintained at a pH of 4˜5;

3) The solution was subjected to electromagnetic stirring for 1 hour at 40˜50° C.;

4) After resting, the supernatant liquor was discarded after delamination, and 10.00 g of Zn(NO₃)₂ was weighted out and dissolved in 40 ml water and subjected to electromagnetic stirring for 1 hour;

5) Step 4 was repeated for three times and then the solution was filtered in a buchner funnel in the last time followed by repetitive washing in deionized water to remove impurity ions in the solution and Zn²⁺ out of the framework of the zeolite molecular sieve, the resulting product was placed in an oven and dried for about 30 minutes at 60° C.;

6) The obtained product was triturated in an agate mortar for 10˜15 minutes, then placed in a 30 ml firepot and torrefied for 6 hours in a muffle furnace at 550° C.;

7) The powdered produce was taken out of the firepot and triturated for 10˜15 minutes then replaced into the muffle furnace and torrefied for 6 hours under the same condition to obtain the product H-STI-ZnO powder form.

### Example 5

Assembling of ZSM-5 zeolite and ZnO

1) 10.00 g of Zn(NO₃)₂ was weighted out and dissolved in 40 ml deionized water;

2) 2.00 g of ZSM-5 zeolite and mixed into the above solution and maintained at a pH of 4˜5;

3) The solution was subjected to electromagnetic stirring for 1 hour at 40˜50° C.;

4) After resting, the supernatant liquor was discarded after delamination, and 10.00 g of Zn(NO₃)₂ was dissolved in 40 ml water and subjected to electromagnetic stirring for 1 hour;

5) Step 4 was repeated for three times and then the solution was filtered in a buchner funnel in the last time followed by repetitive washing in deionized water to remove impurity ions in the solution and Zn²⁺ out of framework of the zeolite molecular sieve, the resulting product was placed in an oven and dried for about 30 minutes at 60° C.;

6) The obtained product was triturated in an agate mortar for 10˜15 minutes, then placed in a 30 ml firepot and torrefied for 6 hours in a muffle furnace at 550° C.;

7) The powdered produce was taken out on the firepot and triturated for 10˜15 minutes then replaced into the muffle furnace and torrefied for 6 hours under the same condition to obtain the product ZSM-5-ZnO powder form.

### Example 6

### Assembling of MCM-41 Zeolite and ZnO

1) 10.00 g of Zn(NO₃)₂ was weighted out and dissolved in 40 ml deionized water;

2) 2.00 g of MCM-41 zeolite and mixed into the above solution and maintained at a pH of 4˜5;

3) The solution was subjected to electromagnetic stirring for 1 hour at 40˜50° C.;

4) After resting, the supernatant liquor was discarded after delamination, and 10.00 g of Zn(NO₃)₂ was weighted out and dissolved in 40 ml water and subjected to electromagnetic stirring for 1 hour;

5) Step 4 was repeated for three times and then the solution was filtered in a buchner funnel in the last time followed by repetitive washing in deionized water to remove impurity ions in the solution and Zn²⁺ out of the framework of the zeolite molecular sieve, the resulting product was placed in an oven and dried for about 30 minutes at 60° C.;

6) The obtained product was triturated in an agate mortar for 10˜15 minutes then placed in a 30 ml firepot and torrefied for 6 hours in a muffle furnace at 550° C.;

7) The powdered produce was taken out the firepot and triturated for 10˜15 minutes then replaced into the muffle furnace and torrefied for 6 hours under the same condition to obtain the product H-MCM-ZnO powder form.

### Example 7

### Assembling of X Zeolite and Fe₂O₃

1) 10.00 g of FeSO₄ was weighted out and dissolved in 40 ml deionized water;

2) 2.00 g of X zeolite was weighted out and mixed into the above solution and maintained at a pH of 4˜5;

3) The solution was subjected to electromagnetic stirring for 1 hour at 40˜50° C.;

4) After resting, the supernatant liquor was discarded after delamination, 10.00 g of FeSO₄ was weighted out and dissolved in 40 ml water and subjected to electromagnetic stirring for 1 hour;

5) Step 4 was repeated for three times and then the solution was filtered in a buchner funnel in the last time followed by repetitive washing in deionized water to remove impurity ions ion in the solution and Fe²⁺ out of the framework of the zeolite molecular sieve, the resulting product was placed in an oven and dried for about 30 minutes at 60° C.;

6) The obtained product was triturated in an agate mortar for 10˜15 minutes, then placed in a 30 ml firepot and torrefied for 6 hours in a muffle furnace at 550° C.;

7) The powdered produce was taken out the firepot and triturated for 10˜15 minutes then replaced into the muffle furnace and torrefied for 6 hours under the same condition to obtain the product H—X—Fe₂O₃ powder form.

### Example 8

### Assembling of Y Zeolite and Fe₂O₃

1) 10.00 g of FeSO₄ was weighted out and dissolved in 40 ml deionized water;

2) 2.00 g of Y zeolite and mixed into the above solution and maintained at a pH of 4˜5;

3) The solution was subjected to electromagnetic stirring for 1 hour at 40˜50° C.;

4) After resting, the supernatant liquor was discarded after lamination, and 10.00 g of FeSO₄ was weighted out and dissolved in 40 ml water and subjected to electromagnetic stirring for 1 hours

5) Step 4 was repeated for three times and then the solution was filtered in a buchner funnel in the last time followed by repetitive washing in deionized water to remove impurity ions in the solution, the resulting product was placed in an oven and dried for about 30 minutes at 60° C.;

6) The obtained product was triturated in an agate mortar for 10˜15 minutes, then placed in a 30 ml firepot and torrefied for 6 hours in a muffle furnace at 550° C.;

7) The powdered produce was taken out the firepot and triturated for 10˜15 minutes then replaced into the muffle furnace and torrefied for 6 hours under the same condition to obtain the product H—Y—Fe₂O₃ powder form.

### Example 9

### Assembling of A Zeolite and Fe₂O₃

1) 10.00 g of FeSO₄ was weighted out and dissolved in 40 ml deionized water;

2) 2.00 g of A zeolite was weighted out and mixed in the above solution and maintained at a pH of 4˜5;

3) The solution was subjected to electromagnetic stirring for 1 hour at 40˜50° C.;

4) After resting, the supernatant liquor was discarded after lamination, 10.009 of FeSO₄ was weighted out and dissolved in 40 ml water and subjected to electromagnetic stirring for 1 hour;

5) Step 4 was repeated for three times and then the solution was filtered in a buchner funnel in the last time followed by repetitive washing in deionized water to remove impurity ions in the solution, the resulting product was placed in an oven and dried for about 30 minutes at 60° C.;

6) The obtained product was triturated in an agate mortar for 10˜15 minutes, then placed in a 30 ml firepot and torrefied for 6 hours in a muffle furnace at 550° C.;

7) The powdered produce was taken out the firepot and triturated for 10˜15 minutes then replaced into the muffle furnace and torrefied for 6 hours under the same condition to obtain the product H-A-Fe₂O₃ powder form.

### Example 10

### Assembling of STI Zeolite and Fe₂O₃

1) 10.00 g of FeSO₄ was weighted out and dissolved in 40 ml deionized water;

2) 2.00 g of STI zeolite was weighted out and mixed into the above solution and maintained at a pH of 4˜5;

3) The solution was subjected to electromagnetic stirring for 1 hour at 40˜50° C.;

4) After resting, the supernatant liquor was discarded after lamination, 10.00 g of FeSO₄ was weighted out and dissolved in 40 ml water and subjected to electromagnetic stirring for 1 hour;

5) Step 4 was repeated for three times and then the solution was filtered in a buchner funnel in the last time followed by repetitive washing in deionized water to remove impurity ions in the solution, the resulting product was placed in an oven and dried for about 30 minutes at 60° C.;

6) The obtained product was triturated in an agate mortar for 10˜15 minutes, then placed in a 30 ml firepot and torrefied for 6 hours in a muffle furnace at 550° C.;

7) The powdered produce was taken out the firepot and triturated for 10˜15 minutes then replaced into the muffle furnace and torrefied for 6 hours under the same condition to obtain the product H-STI-Fe₂O₃ powder form.

### Example 11

### Assembling of MCM-41 Zeolite and Fe₂O₃

1) 10.00 g of FeSO₄ was weighted out and dissolved in 40 ml deionized water;

2) 2.00 g of MCM-41 zeolite and mixed into the above solution and maintained at a pH of 4˜5;

3) The solution was subjected to electromagnetic stirring for 1 hour at 40˜50° C.;

4) After resting, the supernatant liquor was discarded after lamination, and 10.00 g of FeSO₄ was weighted out and dissolved in 40 ml water and subjected to electromagnetic stirring for 1 hour;

5) Step 4 was repeated for three times and then the solution was filtered in a buchner funnel in the last time, repetitive washing in deionized water to remove impurity ions in the solution, for about 30 minutes at 60° C.;

6) The obtained product was triturated in an agate mortar for 10˜15 minutes, then placed in a 30 ml firepot and torrefied for 6 hours in a muffle furnace at 550° C.;

7) The powdered produce was taken out the firepot and triturated for 10˜15 minutes then replaced into the muffle furnace and torrefied for 6 hours under the same condition to obtain the product H-MCM-Fe₂O₃ powder form.

### Example 12

### Assembling of CeO₂ Nano-Cluster in X, Y, A, ZSM-5, STI, and MCM-41 Zeolite

1) 10.00 g of Ce(NO₃)₂ was weighted out and dissolved it in 40 ml deionized water;

2) 2.00 g of zeolite (any one of X, Y, A, ZSM-5, STI, and MCM-41) was weighted out and mixed into the above solution and maintained at a pH of 4˜5;

3) The solution was subject to electromagnetic stirring for 1 hours at 40˜50° C.;

4) After resting, the supernatant liquor was discarded after delamination, and 10.00 g of Ce(NO₃)₂ was weighted out and dissolved in 40 ml water and subjected to electromagnetic stirring for 1 hour;

5) Step 4 was repeated for three times and then the solution was filtered in a buchner funnel in last time, repetitive washing in deionized water to remove impurity ions in the solution, the resulting product was placed in an oven and dried for about 30 minutes at 60° C.;

6) The obtained product was triturated in an agate mortar for 10˜15 minutes, then placed in a 30 ml firepot and torrefied for 6 hours in a muffle furnace at 550° C.;

7) The powdered produce was taken out the firepot and triturates for 10˜15 minutes then replaced into the muffle furnace and torrefied for 6 hours under the same condition to obtain the product.

### Example 13

### Assembling of TiO₂ Nano-Cluster in X, Y, A, ZSM-5, STI, and MCM-41 Zeolite

1) 10.00 g of TiCl₃ was weighted out and dissolved in 40 ml deionized water;

2) 2.00 g of zeolite (any one of X, Y, A, ZSM-5, STI, and MCM-41) was weighted out and mixed into the above solution and maintained at a pH of 4˜5;

3) The solution rested for 1 hour at room temperature;

4) The rested solution was filtered and the filtrate was repetitively washed in deionized water to remove impurity ions in the solution, then placed in an oven and dried for about 30 minutes at 60° C.;

5) The obtained product was triturated in an agate mortar for 10˜15 minutes, then placed in a 30 ml firepot and torrefied for 6 hours in muffle furnace at 550° C.;

7) The powdered produce was taken out the firepot and triturated for 10˜5 minutes then replaced into the muffle furnace and torrefied for 6 hours under the same condition to obtain the product.

### Example 14

The preparation of acrylic acid-azyl varnish:

| | wt % |
|---|---|
| Acrylic resin (70% solid content) | 52.2 |
| amino resin (70% solid content) | 22.3 |
| Tinnvin 292 | 0.5 |
| Tinnvin 1130 | 0.8 |
| drainning silicea (10%) | 5.0 |
| butyl acetate | 5.0 |
| dimethylbenzene | 10.0 |
| ethylene glycol monobutyl ether acetate | 2.7 |
| n-butyl alcohol | 1.5 |

### Synthetic Method

1 Resin such as acrylic resin and amino resin were precisely weighted out and aced into clean and separated vessels;
2 A high boiling point solvent such as butyl acetate and ethylene glycol butyl ether acetate was added into resin to make it be diluted while gradually increasing the stirring rate;
3 The Tinuvin 272 was precisely weighted out and diluted with butyl acetate or dimethylbenzene to make it dispersed;
4 Different kinds of auxiliary agents such as draining silica were weighted out and diluted by the same method and then adding into the vessel;
5 The remaining solvent were added into the vessel and the contents were dispersed under high speed (2000˜3000 rpm) for 20˜30 mins.

### Example 15

The preparation of the sun block:

| | | wt % |
|---|---|---|
| A: | refining water | 50 |
| | polyoxyalkylene | 12 |
| | polyacrylic acid solution | 2 |
| | sodium lauryl sulfate | 0.5 |
| | caisson | 0.1 |
| B: | isopropyl myristate | 10 |
| | isopropyl palmitate | 10 |
| | acetylated lanolin | 5 |
| | t-butyl hydroxyl anisole | 0.05 |
| C: | nano-composite UV-resistant agent | 8 |
| | mica powder | 1 |
| D: | fragrance essence | 0.85 |

### Synthetic Method:

Components A and B respectively mixed and stirred to cause them be resolved, the components A, B, and C were emulsified and component E was added thereto and the resultant mixture was rested for 24 hours.

1. A UV-resistant material which comprises a molecular sieve based host-guest nano-composite which is resistant to ultraviolet radiation.

2. The UV-resistant material of claim 1, wherein the host-guest nano-composite comprises a host material selected from one or more types of microbore zeolite molecular sieve materials.

3. The UV-resistant material of claim 1, wherein the host-guest nano-composite comprises a guest material selected from one or more of TiO₂, ZnO, CeO₂, and Fe₂O₃ metal oxide nano-clusters.

4. A method of producing a UV-resistant material that has a molecular sieve based host-guest nano-composite structure which method comprises providing any one or more of TiCl₃, ZnCl₂, Zn(NO₃)₂, CeCl₃, Ce(NO₃)₃, FeCl₃, Fe(NO₃)₃, FeSO₄ as the initiating material and synthesizing the formation of host-guest nano-composite materials by means of ion exchange, whereby at least one TiO₂, ZnO, CeO₂, and Fe₂O₃ metal oxide nano-clusters couple to the molecular sieve compound and produce a UV-resistant material.

5. The method of claim 4, wherein the ion exchange process comprises following steps:
a) dissolving the initiating material in water,
b) adding a molecular sieve material into the solution of step a),
c) resting or stirring the mixture from step b) for 1˜6 hours,
d) filtering a product from the rested mixture,
e) washing, drying, and torrefying the product from step d) for 4-24 hours at 400-600° C.

6. The method of claim 4, wherein the ion exchange process comprises following steps:
a) dissolving the initiating material in water,
b) adding low-silicon molecular sieve material into the solution from step a),
c) resting the mixture from step b) for 1 hour,
d) filtering a product from the rested mixture,
e) subjecting the product from step d) to washing, drying at 80° C., and torrefying for 12 hours at 500° C.

7. The method of UV-resistant material of claim 1, the initiating material comprises butyl titanate and a host-guest nano-composite material having a TiO2 cluster within molecular sieve material is produced by a hydrolytic reaction.

8. The method of claim 7, wherein the hydrolytic reaction comprises following steps:
a) mixing butyl titanate with a high-silicon molecular sieve material in a non-polar solvent under inert gas shielding,
b) refluxing and agitating the mixture from step a) for 4-48 hours at 50-100° C.,
c) washing a product from step b) with an alcohol based solvent,
d) drying the product from step c) at 60-100° C., and
e) torrefying the dried product for 4-24 hours at 400-600° C.

9. A cosmetic formulation that comprises the UV-resistant material of claim 1.

10. A coating composition that comprises the UV-resistant material of claim 1.

11. A rubber composition that comprises the UV-resistant material of claim 1.

12. A plastic composition that comprises the UV-resistant material of claim 1.

13. The UV-resistant material of claim 2, wherein sieve material comprises at least one type of sieve material selected from X, Y, A, STI, and ZSM-5 type sieve materials.
